(19) United States
(12) Patent Application Publication
(10) Pub. No.: US 2024/0341936 A1
(43) Pub. Date: Oct. 17, 2024

(54) DEVICE FOR CLEANING SURFACES AND USE THEREOF

(71) Applicant: epitome GmbH, Vienna (AT)

(72) Inventors: Andreas RAMBERGER, Vienna (AT); Florian SCHELLNAST, Pressbaum (AT); Lukas RÖSCH, Vienna (AT); Benjamin LUKITSCH, Vienna (AT); Jan HASENBICHLER, Arnoldstein (AT); Maximillian MALI, Vienna (AT)

(73) Assignee: epitome GmbH, Vienna (AT)

(21) Appl. No.: 18/393,808

(22) Filed: Dec. 22, 2023

(30) Foreign Application Priority Data
Dec. 22, 2022 (DE) 102022134597.1

(51) Int. Cl. A61C 17/34

(52) U.S. Cl. CPC A61C 17/349; A61C 17/3418

(57) ABSTRACT

The invention relates to a device for cleaning surfaces such as teeth, interdental spaces, and adjacent gums, wherein the cleaning device (1) comprises at least one shuttle (2), which is embodied as U-shaped or C-shaped in order to encompass a subregion of a dental arch quadrant, wherein the shuttle (2) defines a cleaning space (8), wherein filaments (7) or filament bundles (7) extend into the cleaning space (8) in brush-like fashion from the regions (6, 13) that define the cleaning space (8).

The invention relates to a device for cleaning surfaces and the use thereof.

In particular, it involves a device for cleaning teeth and adjacent gums.

The use of brushes for cleaning teeth and gums has been known for a long time; manual toothbrushes are used, which have a wide variety of bristle shapes and layouts; for example, the bristles protrude orthogonally from the support in the simplest variant whereas in somewhat more complex designs, they can be combined into bristle bundles that are inclined relative to one another and can also be of different lengths.

In addition, electric toothbrushes are known in which for example a circular, rounded disk-like bristle support has a plurality of bristle bundles, which extend away from it orthogonally and execute alternating rotating movements around a vertical axis.

It is also known to embody a brush head that vibrates.

All methods share the fact that the user inserts the brush into the oral cavity by means of a handle and in the oral cavity, guides it over the tooth surfaces and partly also over the adjacent gums.

In this connection, users of electric toothbrushes are now assisted by sound, light, or vibration signals that indicate how and when to brush and in particular, when it is time to switch from one area of the oral cavity to the next.

In addition, some electric toothbrushes also have a pressure control in order to ensure that the pressure during brushing is not excessive, which would lead to an increase in abrasion, especially in connection with abrasive components in the toothpaste.

The disadvantage of the well-known embodiments mentioned above is that they do not achieve precise brushing and often, users are not trained in how to use these tooth cleaning devices, which means there is a potential for incorrect brushing.

This incorrect brushing can result in certain areas not being brushed sufficiently while other areas may possibly be brushed too much and thus be exposed to an increased abrasion, for example of tooth material.

In addition, both manual toothbrushes and electric toothbrushes have the disadvantage that the very sensitive gums are often not treated properly and in particular, are either brushed too little so that biofilm remains in the pockets, which is harmful there, or in particular, the gums are also irritated or damaged due to incorrect brushing guidance or also misaligned bristles.

This is known to cause periodontitis and can subsequently lead to serious illness.

With conventional devices, it is also difficult to correctly reach the interdental spaces, i.e. the spaces between the teeth, and to perform a cleaning there.

The object of the invention is to provide a cleaning device with which the manual tooth cleaning or more precisely tooth cleaning with brushes is performed in an automated way such that the cleaning result is improved and the potential for damage is significantly reduced.

The object is attained with a cleaning device having the features of claim 1.

Advantageous modifications are disclosed in the dependent claims thereof.

Whenever a “vertical axis of a tooth” is mentioned below, this refers to the axis extending from the root of the tooth to the crown of the tooth. When a “transverse axis of a tooth” is mentioned, this refers to the axis extending from the inside of the mouth to the outside. When the “longitudinal axis of a tooth” is mentioned, this refers to the axis extending from a rear transverse surface of the tooth, which defines the interdental space relative to the next tooth, to the front transverse surface of the tooth. Curvatures are disregarded or smoothed out in this connection so that all three axes are perpendicular to one another.

According to the invention, a device with at least one C-shaped so-called shuttle is embodied, which is dimensioned so that it can encompass the teeth and the adjacent gums of a dental arch quadrant. This at least one C-shaped shuttle is able to move in a limited way around the vertical axis of the tooth. In particular, the shuttle is embodied so that it can oscillate around the vertical axis of the tooth.

In one embodiment, the device is guided over the teeth by means of a moving device and consists of the one or more shuttles.

Preferably, the shuttles are embodied with a plurality of flexible or elastic arms, which encompass the teeth and the adjacent gums.

For example, the flexible arms are elastic and in particular rubber-elastic plastic arms, which are embodied with filaments oriented toward the surfaces to be cleaned.

In this case, the filaments can be oriented toward the lateral tooth surfaces and the adjacent gums in the use position. In addition, the shuttles can also be equipped with additional filaments in order to improve the cleaning power on the occlusal surfaces.

With a basically C-shaped embodiment of the shuttles, this means that the filaments are oriented into the inside of the C or are at least oriented inward laterally.

In the preferred embodiment, the shuttles are rotated in an oscillating rotary fashion by means of a suitable mechanical moving apparatus so that the arms equipped with filaments perform a first sweeping motion over the surfaces to be cleaned.

By positioning the arms and filaments particularly in such a way that the filaments are oriented not radially inward, but in a radially/tangentially overlapping fashion, it is also possible to execute a plunging movement toward the cleaning surface in order to reach hard-to-clean locations such as interdental spaces, gingival pockets, and gum lines.

The guidance over the teeth can be performed manually by the user by means of a handle, semi-automatically with a handle and a support that moves the shuttle or shuttles, or fully automatically with a supporting and moving device to be inserted into the mouth.

Since the shuttle is used to clean three sides of the teeth simultaneously, the filaments can press into all of the interdental spaces thanks to the plunging movement and it is possible to adjust the required contact pressure, cleaning time, and intensity, thus eliminating incorrect use.

In this case, the cleaning is achieved by the contact of the filaments with the cleaning surface through a combination of one or more possible movement patterns of the shuttles.

These movement patterns are different and independent rotationally deflected oscillating movements of the whole shuttle or of corresponding supports of the brush-like filament assemblies, which are transmitted for example by means of different coupled cams, and the overlying translatory movement of the whole shuttle by means of a moving device.

A first movement in this connection is a reversing swiveling around the vertical axis of the tooth. The reversing of the movement direction in this case can occur with a predetermined frequency or with changeable frequencies. The amplitude can be adapted to previously measured tooth widths and in particular can be adapted so that the elastic arms do not collide with the teeth.

This first movement can be superimposed with a second movement, which is an eccentric, rotating motion around the longitudinal axis of the tooth along the transverse axis of the tooth.

The first movement can also be superimposed with a third movement, which is a reversing swiveling around the longitudinal axis of the tooth.

All three movements can be superimposed or executed successively.

These movement patterns are transmitted, for example, by a motor via one or more shafts or threaded rods and are superimposed with the overlying translatory movement of the whole shuttle by means of the moving device. The intensity of the cleaning can be controlled via the frequency of the oscillations and via the dwell time on the teeth.

The device with the at least one C-shaped shuttle can be guided over the teeth of a dental arch quadrant, wherein the cleaning heads in this case clean the teeth and the adjacent gums.

In this connection, the C-shaped shuttle can be positioned on the moving device, which guides and moves the shuttle over the teeth in an automated way and in so doing, makes sure that the teeth are cleaned from at least two or better three sides simultaneously.

The embodiment of the at least one C-shaped shuttle enables a locally selective cleaning of surfaces such as teeth, interdental spaces, and gums.

The cleaning intensity and the cleaning duration can therefore also be adapted on the one hand by adjusting the speed of the shuttle movement over the teeth and on the other hand, by adjusting the speed of the rotation of the cleaning elements but also by adjusting their movement over the teeth and their dwell time. On the one hand, this allows the energy consumption to be optimized and on the other hand, it allows the cleaning to be concentrated in those places where it needs to be the most intensive, which can be determined as needed by means of corresponding detection methods.

In one embodiment, the shuttle is embodied not as a C-shaped housing, but rather as a double C-shaped housing with openings on opposite sides so that an upper and lower row of teeth of the upper and lower dental arch quadrants, respectively, can be cleaned at the same time.

Consequently, the corresponding filaments can then be embodied in each of the C-shaped shuttle parts.

Because the shuttles oscillate around the vertical axis, the individual elastic arms of the shuttle, i.e. the arms that laterally encompass the tooth, come closer to the surface to be cleaned and then move away from it again. As a result of this, a focused pushing or plunging movement toward the cleaning surface and away from it is executed.

In this case, the filaments are in particular positioned so that one filament assembly executes the plunging movement during the first approaching movement of the arm and another filament assembly does this during the second retracting movement. Since the shuttles are guided over the teeth, each area is swept over by filaments once in one direction and once in the other direction, which increases the cleaning effect.

In this case, the filament assemblies can have a V shape, which, relative to the surface to be cleaned, opens toward the surface.

In addition, filaments of different lengths, hardnesses, and rigidities can be used in the filament assembly. In particular, selected filaments can have a different hardness or rigidity than the other filaments, i.e. are softer or harder, or can have a different diameter, or their filament ends can have a different shape, curvature, or contour.

In addition, the filaments can be combined into filament groups in such a way that the filament groups form a feather surface like a bird's feather that extends inward and then outward from the elastic arm and rests more tangentially than radially against the surfaces to be cleaned. Such a feather surface can push biofilm from the tooth in a particularly effective way, but can also clean the gums and the gum lines without damaging them. The filaments in this case are positioned and possibly even bonded to one another chemically, mechanically, or thermally so that a combined cleaning edge of the filaments is formed. The individual filaments can also be curved along the edge in the region of their free ends in order to form a particularly stable, but also soft edge. The combined edge also has a stabilizing effect, wherein through the combined spring force of all of the filaments, the filament group stands on its edge when it meets with resistance, for example due to the presence of biofilm or other contaminants, and thus adapts the spring hardness and improves the cleaning action.

The feather-shaped filament group can likewise be formed with filaments that have a different length, hardness, or rigidity than the other filaments, i.e. are softer or harder, or have a different diameter, or their filament ends have a different shape, curvature, or contour. In particular, the filaments of such a group can be adjusted so as to stress the sensitive gums as little as possible. In this regard, these filaments can have a reduced bending stiffness in the region of the gums in order to make sure that the ends of the filaments do not pierce the soft tissue.

As explained above, the device can be used in that the user dispenses, for example, a cleaning fluid or toothpaste into one or all of the shuttles and in this regard, handles it analogously to a toothbrush. When switched on, the shuttle is guided over the teeth with a handle analogously to an electric toothbrush. In this case, the device can adapt to the cleaning surface, particularly by means of the type and shape of the filament assemblies, wherein the shuttles can possibly have steering and guiding elements with which the shuttles are guided along the teeth without excessive pressure or tilting by the user.

The cleaning device according to the invention can easily be adapted to existing handles of electric toothbrushes and increases their cleaning power significantly.

In addition, the cleaning device according to the invention can also include two corresponding cleaning shuttles positioned on a base element in such a way that they point diametrically away from each other and it is thus possible to clean the corresponding dental arch quadrants of the upper jaw and lower jaw.

In another embodiment, the user dispenses the cleaning fluid into all of the shuttles and inserts the device into the mouth, wherein in this case, the shuttles themselves are automatically guided over the teeth by the device, meaning that the shuttles in this case are movably positioned on a supporting unit.

In yet another embodiment, the user inserts the device into the mouth by means of a supporting and moving device, wherein the device then automatically guides the shuttle or shuttles over the teeth. During the guidance over the teeth, the device can automatically dispense cleaning fluid into the shuttles. In this case, the device can used compiled geometrical or localizing data in order to specify the cleaning and adapt it to the specific situation. This means that the device performs one, several, or all of the actions of the cleaning heads from the following non-exhaustive group:
rotation speed
rotation frequency
pressure on the cleaning surface
plunging into interdental spaces
dwell time in a location
type of cleaning fluid
quantity of cleaning fluid

The invention thus relates in particular to a device for cleaning surfaces such as teeth, interdental spaces, and adjacent gums, wherein the cleaning device comprises at least one shuttle, which is embodied as U-shaped or C-shaped in order to encompass a subregion of a dental arch quadrant, wherein the shuttle defines a cleaning space, wherein filaments or filament bundles extend into the cleaning space in brush-like fashion from the regions that define the cleaning space.

According to one modification, a shuttle is embodied with at least one base strut and two side struts protruding from the latter as regions defining the cleaning space, wherein the filaments or filament bundles are embodied on at least the side struts.

According to one modification, a shuttle is embodied with at least one base plate and two side plates protruding from the latter as regions defining the cleaning space, wherein the filaments or filament bundles are embodied on at least the side plates.

According to one modification, the at least one shuttle is able to move in a limited way around the vertical axis of the tooth and in particular, is able to oscillate around the vertical axis of the tooth.

According to one modification, in order to encompass the respective dental arch quadrants of the upper and lower jaw, two shuttles are provided on the cleaning device, whose cleaning spaces are oriented diametrically away from each other.

According to one modification, the side struts or side plates of a shuttle are positioned on the base strut or base plate in an elastic or rubber-elastic fashion.

According to one modification, the side struts or side plates of a shuttle are embodied as elastic or rubber-elastic.

According to one modification, in the use position, the filaments or filament bundles are oriented toward the lateral tooth surfaces and the adjacent gums.

According to one modification, in the base strut or the base plate the shuttle has filaments or filament bundles in order to achieve a cleaning of the occlusal surfaces.

According to one modification, the shuttle has a drive fitting that is embodied to be mechanically coupled to a drive unit in order to enable a rotary, oscillatory rotation.

According to one modification, filaments or filament bundles of different lengths, hardnesses, or rigidities are positioned in the filament assembly.

According to one modification, selected filaments or filament bundles have a different hardness or rigidity than the other filaments or filament bundles, i.e. are softer or harder, or have a different diameter, or their filament ends have a different shape, curvature, or contour.

According to one modification, the filaments or filament bundles are positioned so that positioned so that first filaments or filament bundles execute a plunging movement during the first approaching movement of the shuttle and other, second filaments or filament bundles do this during the second retracting movement.

According to one modification, filament assemblies composed of a plurality of filaments or filament bundles have a V shape, which, relative to the surface to be cleaned, opens toward the surface.

According to one modification, the base strut or base plate is approximately dimensioned so that it reaches across a tooth to be cleaned transversely from an inside of the oral cavity to an outside of the oral cavity, wherein the orientation is basically such that when in use, the shuttle, the base strut, or base plate is in an orientation, which extends approximately parallel to the crown of a tooth, but protrudes beyond it laterally.

According to one modification, a drive fitting is centrally positioned in the middle of the base strut or base plate and can be used to connect the base strut or base plate to a drive apparatus so that the base strut or base plate can be rotated or oscillated around the vertical axis, which extends concentrically in the middle of the drive fitting.

According to one modification, filaments or filament bundles are positioned on the base strut or base plate.

According to one modification, the cleaning device is embodied with two base struts and correspondingly four side struts, wherein the base struts are embodied as crossing each other in an X shape, wherein the drive fitting is positioned at the center of the X-shaped embodiment.

According to one modification, the two base struts in this case enclose two opposing smaller angles α and two opposing larger angles β so that the X is not symmetrical.

According to one modification, in the region of the larger angles β, the adjacent base struts are connected with circular segment-shaped connecting struts.

According to one modification, the connecting struts are embodied with filaments or filament bundles that are oriented into the cleaning space.

According to one modification, the drive fitting is positioned in the vicinity of the base plate, wherein the base plate is in particular embodied in the form of an elongated rectangle.

According to one modification, in the vicinity of a longitudinal center of the base plate, S-shaped spring struts protrude outward, wherein the side plates are positioned at the outer ends of the spring struts, wherein the side plates extend away from a plane of the base plate and are oriented orthogonal to the base plate or diverging outward from the vertical axis of the base plate, which axis extends concentrically through the drive fitting.

According to one modification, the side plates in this case are embodied as angled in such a way that an outward-facing wall is embodied along a longitudinal center forming an angle of less than 180° around the latter and an inner side is embodied along the longitudinal center forming an angle of greater than 180°, wherein the side plate sections, which are thus formed and are positioned at an angle relative to each other, are embodied with filaments or filament bundles that are thus positioned in a V shape in the direction toward the cleaning space.

According to one modification, the shuttle is embodied as a swivel plate, which is positioned on a base plate of the cleaning device and can be driven to oscillate relative to the base plate.

According to one modification, in corner regions, the swivel plate has filament groups embodied in the form of a bird's feather, wherein the filaments originate in the vicinity of side regions of the swivel plate and extend toward each other in pairs with their free ends curved toward the surface to be cleaned, wherein between the filament groups cleaning regions are formed so that the filament groups have an outer feather surface and an inner feather surface, which are embodied as curved so that they point more tangentially than radially toward a surface to be cleaned.

According to one modification, the feather-shaped filament groups taper toward the outside and/or widen or lengthen as they extend away from the swivel plate in such a way that an intensified plunging is enabled in the region of the tooth necks, gingival pockets, and in particular interdental spaces.

Another aspect of the invention relates to the use of an above-mentioned device, wherein the cleaning intensity and the cleaning duration are adapted by controlling one, several, or all of the actions in the following group: speed of the shuttle movement over the teeth, speed of the oscillation of the shuttle or shuttles, and dwell time on the tooth.

Another aspect of the invention relates to the use of an above-mentioned device, wherein a cleaning fluid or toothpaste is dispensed into one or all of the shuttles and when switched on, the shuttle is guided over the teeth with a handle analogously to an electric toothbrush.

Another aspect of the invention relates to the use of an above-mentioned device, wherein the cleaning device is positioned on and adapted to existing handles of electric toothbrushes.

Another aspect of the invention relates to the use of an above-mentioned device, wherein the shuttles themselves are automatically guided over the teeth by the cleaning device, meaning that the shuttles in this case are movably positioned on a supporting unit.

Another aspect of the invention relates to the use of an above-mentioned device, wherein the cleaning device is inserted into the mouth with a supporting and moving device, wherein the shuttle or shuttles is/are then automatically guided over the teeth.

Another aspect of the invention relates to the use of an above-mentioned device, wherein the device can use compiled geometrical or localizing data in order to specify the cleaning and adapt it to the specific situation, wherein the device controls or performs one, several, or all of the actions from the following non-exhaustive group:
oscillation speed
rotation frequency
pressure on the cleaning surface
plunging into interdental spaces
dwell time in a location
type of cleaning fluid
quantity of cleaning fluid

The invention will be explained by way of example based on the drawings. In the drawings:

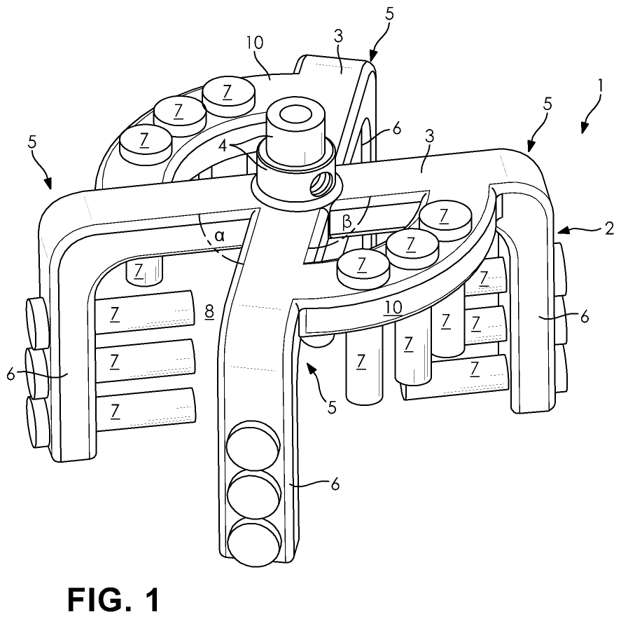

FIG. 1: is a schematic depiction of a first embodiment of a shuttle of the cleaning device according to the invention;

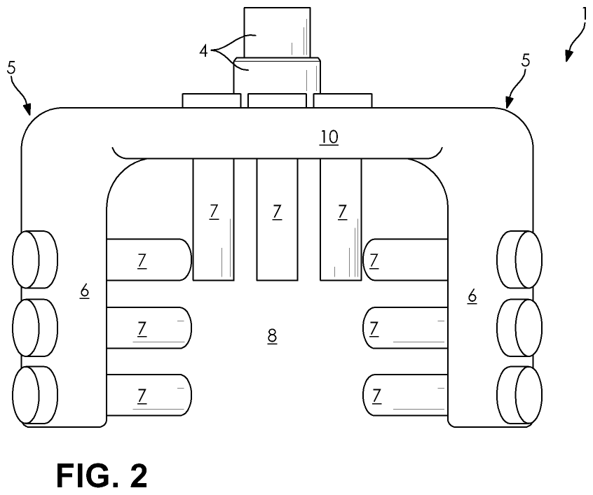

FIG. 2: shows a side view of the shuttle from FIG. 1;

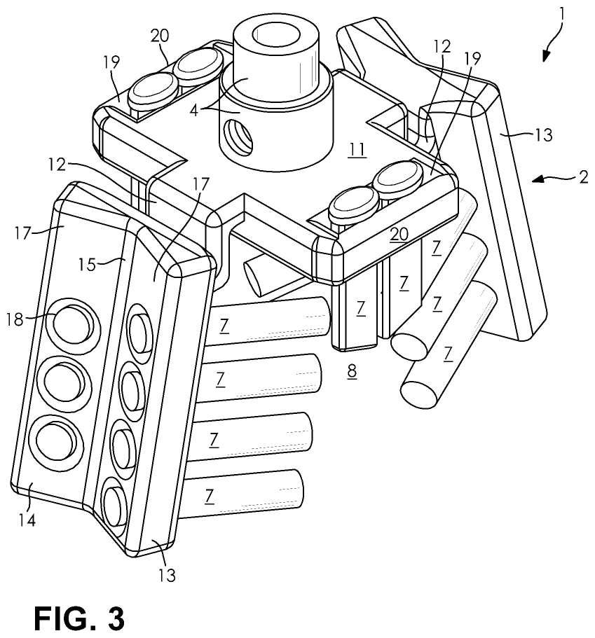

FIG. 3: shows another shuttle embodiment according to the invention;

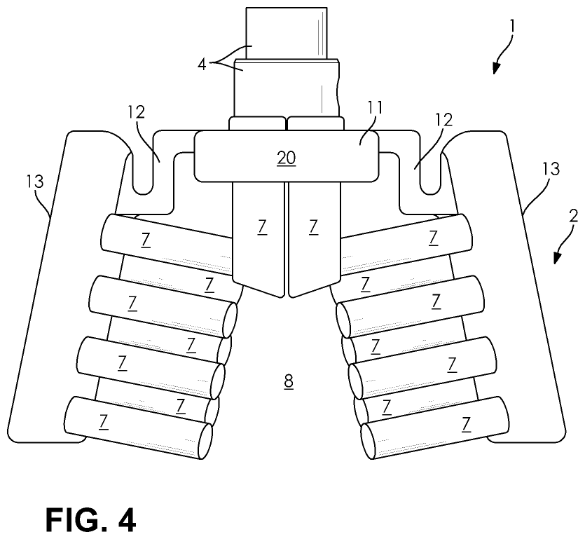

FIG. 4: shows a side view of the shuttle from FIG. 3;

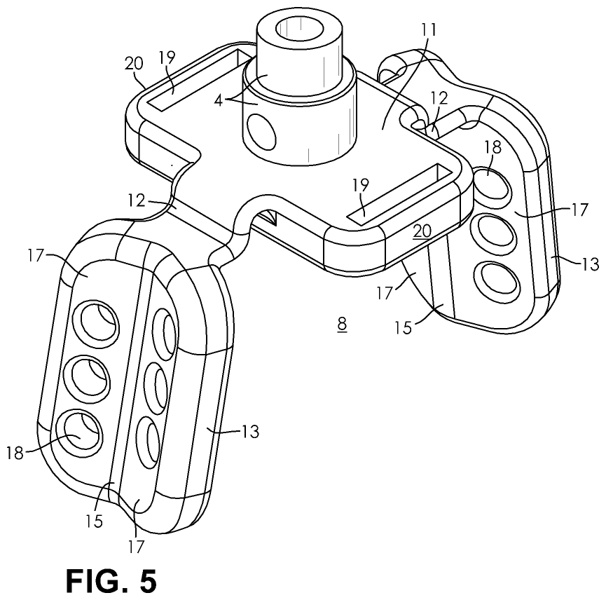

FIG. 5: shows another embodiment of the shuttle from FIG. 3 with immovable side arms;

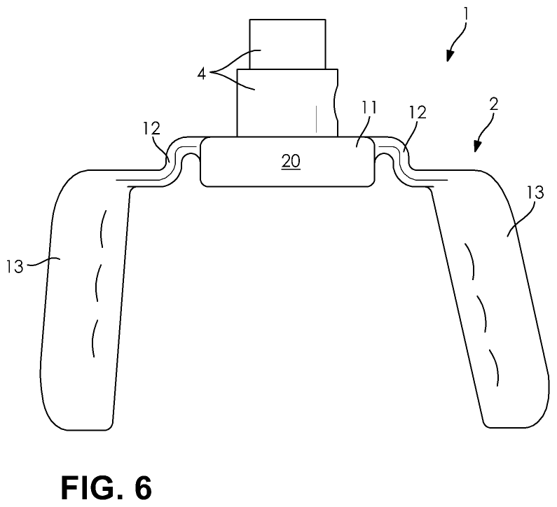

FIG. 6: shows a side view of the shuttle from FIG. 5.

A cleaning device 1 according to the invention comprises at least one cleaning shuttle 2. The cleaning shuttle 2 is embodied as an inverted U shape in order to encompass a surface to be cleaned and in particular a tooth to be cleaned. For this purpose, in its simplest embodiment, the cleaning shuttle 2 has a base strut 3.

The base strut 3 is approximately dimensioned so that it can transversely span a tooth to be cleaned, from an inside of the oral cavity to an outside of the oral cavity. In this case, the orientation is basically such that when in use, the cleaning shuttle or more precisely the base strut 3 of the cleaning shuttle 2 is in an orientation, which extends approximately parallel to the crown of a tooth, but protrudes beyond it laterally.

A drive fitting 4 is centrally positioned in the middle of the base strut 3 and can be used to connect the base strut 3 to a drive apparatus so that the base strut 3 can be rotated or oscillated around its vertical axis, which extends concentrically in the middle of the drive fitting.

At least one side strut 6 extends from the base strut 3 in each of the end regions 5 of the base strut 3, wherein the side struts 6 extend in the same direction, parallel to each other and orthogonal to the base strut 3.

The base strut 3 and the side struts 6 thus form an approximately U-shaped narrow structure, wherein the side struts 6 have filaments 7 or filament bundles 7 oriented inward.

In a simplest embodiment of the invention in which two side struts 6 protrude from a base strut 3, the filaments 7 or filament bundles 7 are thus oriented toward one another extending into a cleaning space 8 defined by the base strut 3 and the side struts 6.

In one embodiment, filaments 7 or filament bundles 7 can also be positioned on the base strut 3, particularly on both sides of the drive fitting 4, so that during the tooth cleaning, such a cleaning device 1 is able to clean both the top surface and the sides of a tooth as well as the adjacent gums.

The cleaning device 1 can be connected to a drive unit (not shown) via the drive fitting 4.

This drive unit is correspondingly embodied to execute an oscillating rotating motion in such a way that at least the filaments 7 or filament bundles 7 of the side struts 6 are actuated on the surface of the surface to be cleaned, i.e. in particular a tooth and the adjacent gums, with the filament ends brushing over the surface.

Through an externally superimposed movement along a dental arch quadrant, every region of a tooth and the gums is thus reached, wherein the oscillating motion of the cleaning device also produces the closest approach to the surface in the end regions. This also results in a good cleaning of lower-lying regions, in particular the interdental spaces and the flanks of the teeth in the region of the interdental spaces.

In this case, it is particularly advantageous that such a cleaning device can also be used with conventional electric toothbrushes that are acted on with an oscillating motion and in this connection, enables a significantly improved cleaning power.

In another advantageous embodiment in which parts that are the same are labeled with the same reference numerals (FIG. 1, FIG. 2), in order to increase the cleaning power, the cleaning device 1 is embodied with two base struts 3 and correspondingly four side struts 6, wherein the base struts 3 are embodied as crossing each other in an X shape, wherein in this case as well, the drive fitting 4 constitutes the center point of the X-shaped embodiment.

The two base struts 3 in this case enclose two opposing smaller angles α and two opposing larger angles β so that the X is not symmetrical. In the region of the larger angles β, the adjacent base struts are connected with circular segment-shaped connecting struts 10.

On the one hand, the connecting struts 10 serve a stabilizing function and on the other hand, they can also support filaments 7 or filament bundles 7, which protrude into the cleaning space 8.

Such an embodiment has the advantage that improved cleaning is achieved due to the angled positioning of the filaments 7 or filament bundles 7 on the surface to be cleaned and the higher overall number of filaments 7.

Particularly in the region of the interdental spaces and through the positioning of filaments 7 in the connecting struts, a more powerful cleaning and brushing movement occurs due to the distance of the base struts 3 from the center point.

In the embodiments mentioned above and in this one, in particular, but not only, the end regions 5 that ultimately connect the side struts 6 and the base struts 3 are embodied as elastic and in particular rubber-elastic. This enables a flexing of the side struts 6, which can absorb excessive pressures if necessary. In addition, the side struts 6 can also be embodied as entirely elastic and in particular rubber-elastic.

In another advantageous embodiment (FIG. 3), the drive fitting 4 is positioned in the region of a base plate 11, wherein the base plate 11 is embodied, for example, in the form of an elongated rectangle.

In the region of a longitudinal center of the base plate 11, S-shaped spring struts 12 protrude outward, wherein the side plates 13 are positioned at the outer ends of the spring struts 12. The side plates 13 here extend away from a plane of the base plate 11 and in this case, can be oriented orthogonal to the base plate 11 or diverging outward from the vertical axis of the base plate 11, which axis also passes through the drive fitting 4.

The side plates 13 in this case are embodied as angled in such a way that an outward-facing wall 14 is embodied along a longitudinal center 15 forming an angle of less than 180° around the latter and an inner side is embodied along the longitudinal center 15 forming an angle of greater than 180°. In the side plate sections 17 that are thus formed and are positioned at an angle relative to each other, recesses 18 are embodied for accommodating filaments 7 or filament bundles 7. The recesses 18, however, can also be embodied by filaments that are embodied as integrally joined to the side plates 13 or of one piece with them.

The filaments 7, which correspondingly extend through the recesses 18 from the outside to the inside toward a cleaning space 8, thus diverge outward in the direction toward the cleaning space 8.

Filaments 7 or filament bundles 7 are also supported in recesses 19 in the base plate 11. These are preferably positioned spaced apart from the drive fitting 4 and spring struts 12 and adjacent to the narrow ends 20. As a result, the filaments 7 sweep over the occlusal surfaces when the shuttle 2 oscillates.

This has the advantage that with such an arrangement on the one hand, the side plates 13 are resiliently supported and can thus flex outward in response to a corresponding pressure exerted by the filaments onto the side plates and on the other hand, it is possible to set a minimum contact pressure of the filaments on a surface to be cleaned.

Because the filaments 7 point inward and diverge outward, when the cleaning device 1 of this embodiment oscillates around the vertical axis, the ends of the filaments perform a plunging action in the region of the interdental spaces and the tooth flanks located there, which enables good cleaning.

In another advantageous embodiment (FIG. 5), the corresponding side plates 13 are embodied orthogonal to the base plate in terms of their longitudinal span but are supported on the base plate 11 resiliently by means of the spring elements 12, which in this case are embodied as sharply S-shaped.

In yet another advantageous embodiment (FIGS. 5 & 6), the side plates 13 of this embodiment are affixed to the base plate 11 without resilient support, which enables a small design. This does not exclude the possibility of the side plates in this case being embodied as elastic themselves.

The invention has the advantage of creating a cleaning device that can be guided over the teeth both fully automatically and semi-automatically, wherein an oscillating motion of the cleaning device achieves a particularly good cleaning, wherein in particular the U-shaped embodiment eliminates the need for tilting the brush from the crown of the tooth to the side flanks as is required with known handheld toothbrushes, and in this respect, achieves an ideal user guidance with improved cleaning.

It is also advantageous that through the embodiment and in particular the spatial orientation of the filament groups and also through the embodiment in the form of a bird's feather, a particularly gentle, defined cleaning of the surface is achieved by means of filament ends that push and pull. This reliably tears open a biofilm and removes it or brushes it away.

1-35. (canceled)

36. A device for cleaning surfaces including teeth, interdental spaces, and gums, wherein the cleaning device comprises at least one shuttle, which is embodied as U-shaped or C-shaped in order to encompass a subregion of a dental arch quadrant, wherein the shuttle defines a cleaning space, wherein filaments or filament bundles extend into the cleaning space in brush-like fashion.

37. The device according to claim 36, wherein a shuttle comprises at least one base strut and two side struts protruding from the base strut as regions defining the cleaning space, wherein the filaments or filament bundles are attached to at least the side struts.

38. The device according to claim 37, wherein a shuttle comprises at least one base plate and two side plates protruding from the base plate latter as regions defining the cleaning space, wherein the side plates comprise filaments or filament bundles mounted thereon.

39. The device according to claim 38, further comprising two shuttles oriented away from one another.

40. The device according to claim 37, wherein the side struts or side plates of a shuttle are positioned on the base strut or base plate.

41. The device according to claim 40, wherein in the base strut or the base plate the shuttle has filaments or filament bundles attached thereto.

42. The device according to claim 36, wherein the shuttle has a drive fitting that is capable of being mechanically coupled to a drive unit.

43. The device according to claim 42, wherein the device comprises at least one drive unit, which is capable of producing a first reversing swiveling motion of the shuttle.

44. The device according to claim 43, wherein the at least one drive unit is capable of producing a second eccentric rotating motion of the shuttle.

45. The device according to claim 44, wherein the at least one drive unit, is capable of producing a third reversing swiveling motion of the shuttle.

46. The device according to claim 45, wherein the drive unit is capable of reversing the movement directions with a predetermined frequency or with changeable frequencies.

47. The device according to claim, wherein a first group of filaments have a different hardness or rigidity than a second group of filaments.

48. The device according to claim 36, wherein a first plurality of filaments or filament bundles are capable of executing a plunging movement during an approaching movement of the shuttle and a second plurality of filaments or filament bundles are capable of executing a plunging movement during a retracting movement.

49. The device according to claim 38, wherein a drive fitting is centrally positioned in the middle of the base strut or base plate and is capable of connecting the base strut or base plate to a drive apparatus so that the base strut or base plate can be rotated or oscillated around an axis.

50. The device according to claim 37, wherein the cleaning device comprises two base struts and four side struts, wherein the base struts cross each other in an X shape, wherein the drive fitting is positioned at the center of the X-shape.

51. The device according to claim 50, wherein the two base struts are capable of enclosing two opposing smaller angles α and two opposing larger angles β so that the X-shape is not symmetrical.

52. The device according to claim 51, wherein in the region of the larger angles β, the adjacent base struts are connected with circular segment-shaped connecting struts.

53. The device according to one of claim 52, wherein the connecting struts comprise filaments or filament bundles that are oriented into the cleaning space.

54. The device according to claim 49, further comprising S-shaped spring struts,
wherein proximate a longitudinal center of the base plate the S-shaped spring struts protrude outward,
wherein the side plates are positioned at the outer ends of the S-shaped spring struts,
wherein the side plates (i) extend away from a plane of the base plate and are oriented orthogonal to the base plate or (ii) diverge outward from the vertical axis of the base plate, and
wherein the vertical axis extends concentrically through the drive fitting.

55. A method of cleaning teeth and/or gums, comprising using the device of claim 35 wherein a cleaning intensity and a cleaning duration are adapted by controlling at least one of: speed of the shuttle movement over the teeth, speed of the oscillation of the shuttle or shuttles, and dwell time on the tooth.
